(19) United States
(12) Patent Application Publication
(10) Pub. No.: US 2016/0121585 A1
(43) Pub. Date: May 5, 2016

(54) THERMOPLASTIC POLYMER REPAIR PATCHES AND METHODS OF USING THE SAME

(71) Applicant: Spintech, LLC, Xenia, OH (US)

(72) Inventors: Craig Jennings, Dayton, OH (US); Matthew Everhart, Fairborn, OH (US); Thomas Margraf, Centerville, OH (US); John Riggins, Kettering, OH (US)

(73) Assignee: Spintech, LLC, Xenia, OH (US)

(21) Appl. No.: 14/532,279

(22) Filed: Nov. 4, 2014

(51) Int. Cl. B32B 27/08; B29C 65/48; B29C 65/02; C09J 7/02; B32B 38/00; B32B 27/36; B32B 27/32; B32B 27/30; B29C 65/70; B32B 37/06

(52) U.S. Cl. CPC B32B 27/08; B29C 65/70; B29C 65/4825; B29C 65/022; B32B 37/06; B32B 38/0012; B32B 27/36; B32B 27/32; B32B 27/308; B32B 27/304; C09J 7/0217; B32B 2327/06; B32B 2355/02; B32B 2333/08; B29K 2627/06

(57) ABSTRACT

A method of repairing a manufactured component having a damaged area including: laying a preformed thermoplastic polymer repair patch over the damaged area; heating the thermoplastic polymer repair patch to easily and quickly deform said patch to said damaged area; and bonding said composite patch to said damaged area of said manufactured part. The thermoplastic polymer repair patch including an adhesive layer and a thermoplastic polymer selected from acrylic-polyvinyl chloride, polyethylene terephthalate glycol-modified (PETG), high impact polystyrene, polyvinyl chloride, and high density polyethylene.

### BACKGROUND OF THE INVENTION

The present disclosure generally relates to the repair of manufactured components made from materials such as metals, composites, wood, plastics, ceramic, and glass. It is to be appreciated that the present disclosure has general and specific industrial application in the repair of various materials.

The repair of manufactured parts can be an expensive and time consuming process. If mass produced items, such as car hoods, car bumpers, and other manufactured parts are damaged it is frequently less expensive to replace the entire part than to repair it. Full replacement of manufactured parts is wasteful as well as expensive.

Repairing manufactured parts is expensive and time consuming because regaining the structural rigidity as well as maintaining the potentially complex geometry of the original part is challenging. For example, many manufactured parts are polymers or polymer composites (components produced by impregnating a fibrous or particulate material with a thermoplastic or thermosetting resin to form laminates or layers) because of the advantages of weight saving, high specific mechanical properties, and good corrosion resistance they provide. Such composite components can be of a sandwich construction. When damage occurs to composite structures, a damage crater, crack, or hole will be formed in the object necessitating repair.

The general approach to repair damage in a polymer composite is to remove the damaged section and repair the damage by curing a “prepreg” that is laid over the damaged area. A “prepreg” is a layer of fibrous material impregnated with uncured resin, and it can be cured by the use of an electric blanket with a vacuum bag. The electric blanket applies heat to that area to cure the prepreg. The vacuum bag applies a compaction force to the prepreg.

Repairs using this approach are not however always satisfactory. This is because the inconsistency of the heat provided by the electric blanket leads to unreliability in the curing. Also, the use of vacuum bag compaction is not very effective in removing air from the prepreg so that the repaired area is not necessarily void free. Additionally, it normally takes a long amount of time to remove, repair, replace, and test the damaged component. Finally, the majority of time in using these methods typically involves waiting for the resin in the composite material and filler to cure. If this cure cycle was eliminated, not only would there be a vast reduction in time, but also in the emissions and use of chemicals, eliminating the cleanup and disposal of said chemicals.

Multi-layered repair patches are also known in the art and these repair patches have been used both for repairing holes in drywall material as well as repairing holes in automobile bodies. U.S. Pat. No. 5,075,149 issued to Owens et al. (“Owens”), U.S. Pat. No. 4,707,391 issued to Hoffmann (“Hoffmann '391”) and U.S. Pat. No. 4,135,017 issued to Hoffmann (“Hoffmann '017”) are all directed to multi-layer repair patches.

Owens discloses a three-layered patch with a metal plate disclosed between two polyester sheets. The metal plate is held in place between the two polyester sheets with a semi-solid adhesive such as urethane. The semi-solid adhesive fixedly attaches the two polyester sheets together as well as fixedly attaching the reinforcing metal plate between the two sheets. Owens is not useful for repairs which require the application of bonding material or plaster to the repair patch because the bonding material or plaster cannot readily pass through the mesh due to the presence of the urethane adhesive. Additionally the patch cannot be molded quickly, on-site, without additional time and equipment.

Hoffmann '391 discloses a two-layer patch including a perforated metal plate with an outer fiberglass mesh attached to one side of the plate. A glue or adhesive coating is applied to the surface of the plate that is attached to the surface to be repaired and an additional adhesive coating is applied to the inward-facing surface of the fiberglass mesh to attach the mesh to the metal plate as well as to attach the mesh to the surface under repair.

Hoffmann '017 also discloses a two-layer patch. An inner metal plate is covered with adhesive that secures one surface of the plate to the surface under repair. An outer plate cover is laminated onto the exterior side of the metal plate by means of a layer of adhesive applied to the inward-facing side of the plate cover.

Both of these methods employ metal plates in the final patch which limits the ability of these patches to be easily and quickly molded to the damaged part on-site. Additionally, the use of metal eliminates some of the weight saving advantages of a pure composite or polymer repair patch.

Additionally, the repairs alone in these methods can take anywhere from approximately four hours or more to complete, mainly due to the time necessary to allow curing of the filler and adhesive. When taking into account the time to remove the damaged parts, mold the patch to the damaged area, and replace the part the time involved increases. In addition, despite the use of vacuum equipment to attempt to expel all air entrapped under the patch, the complete absence of such entrapment cannot be guaranteed and non-destructive testing may need to be carried out to ensure the structural integrity of the repair. It will be appreciated that enormous potential savings are possible when the time for repair is reduced considering in many fields, such as the aviation field, downtime of equipment is very expensive. For example, aircraft downtime often runs at $US 100,000.00 per hour allowing for enormous potential savings when the time for repair is reduced.

Shape memory polymer repair patches are also known in the art and these repair patches have been used both for repairing damage to a variety of materials. U.S. Pat. Nos. 7,938,923 and 7,981,229 issued to Hood et al. as well as U.S. Patent Applications 2011-0265936, 2011-0277914, and 2014-0024276 by Hood et al. are all directed to shape memory polymer repair patches. However, Hood '923, '229, '936, '914, and '276 all require deactivation of the shape memory polymer repair patch while the shape memory repair patch is held in the desired deformed shape.

Thus, there is a need for a cheap, quick, and effective method of repairing such mass produced parts and for quickly and reliably repairing aircraft and other high end parts without necessitating actively retaining the repair material in the desired shape during the repair.

### SUMMARY OF THE INVENTION

According to a first aspect of the disclosure, there is provided a method for repairing manufactured parts having a damaged area. The method including preforming a thermoplastic polymer repair patch comprising a repair material into a desired shape. The repair material being made from a thermoplastic polymer selected from the group consisting of acrylic-polyvinyl chloride, polyethylene terephthalate glycol-modified (PETG), high impact polystyrene, polyvinyl chloride, and high density polyethylene. Further, the thermoplastic polymer is heated such that the preformed repair material becomes soft and deformable. The method additionally includes deforming the preformed repair material into a shape that is molded to the damaged area. The deforming of the preformed repair material is achieved by external mechanical force. Finally, the method includes bonding the deformed repair material to the damaged area of the manufactured part. The heating of the repair material, deforming the repair material, and bonding of the deformed repair material can be iteratively repeated in any order to ensure that the repair material is molded to the damaged area.

According to a second aspect of the disclosure, there is provided a method for repairing manufactured parts having a damaged area. The method including preforming a thermoplastic polymer repair patch comprising a repair material into a desired shape. The repair material is made from a thermoplastic polymer selected from the group consisting of acrylic-polyvinyl chloride, polyethylene terephthalate glycol-modified (PETG), high impact polystyrene, polyvinyl chloride, and high density polyethylene. Further, the thermoplastic polymer is heated such that the preformed repair material becomes soft and deformable. The method additionally includes deforming said preformed repair material into a shape that is conformed to the damaged area such that the repair material retains the shape that is conformed to the damaged area without deactivation of the thermoplastic polymer. The deforming of the preformed repair material is achieved by external mechanical force. Additionally, the method includes allowing the deformed repair material to harden and retain its deformed shape without holding the deformed repair material to the damaged area of the manufactured part. Finally, the method includes bonding the deformed repair material to the damaged area of the manufactured part. The heating of the repair material, deforming the repair material, cooling to harden the deformed repair material, and bonding of the deformed repair material can be iteratively repeated in any order to ensure that the repair material is molded to the damaged area.

According to a third aspect of the disclosure, there is provided a patch for repairing manufactured parts having a damaged area. The patch defining a first layer having an adhesive and a second layer having a thermoplastic polymer. The thermoplastic polymer being selected from acrylic-polyvinyl chloride, a polyethylene terephthalate glycol-modified (PETG), a high impact polystyrene, a polyvinyl chloride, and a high density polyethylene. Further the patch made of the thermoplastic polymer becomes soft upon heating and is deformable into a shape that is molded into the damaged area.

Other objects, features and advantages of this disclosure will be apparent from the following detailed description taken in connection with the examples and accompanying drawings and are within the scope of the present disclosure.

### BRIEF DESCRIPTION OF THE DRAWINGS

FIG. 1A is a perspective view of a thermoplastic polymer repair patch;

FIG. 1B is a profile view of an embodiment of the thermoplastic polymer repair patch of FIG. 1A;

FIG. 1C is a profile view of an embodiment of the thermoplastic polymer repair patch of FIG. 1A;

FIG. 2 is a perspective view of a typical pipe with a damaged area;

FIG. 3 is a perspective view of the typical pipe with damage of FIG. 2 repaired by the thermoplastic polymer repair patch of FIG. 1A;

FIG. 4 is a perspective view of a typical pipe with damage at or near a wall, floor, or ceiling;

FIG. 5 is a perspective view of the pipe of FIG. 4 repaired by the thermoplastic polymer repair patch of FIG. 1A;

FIG. 6 is a perspective view of two short pieces of pipe that are to be joined together;

FIG. 7 is a perspective view of a single long pipe created from the two shorter pipes of FIG. 6 joined by the thermoplastic polymer repair patch of FIG. 1A;

FIG. 8 is a perspective view of two flat articles that are to be joined together;

FIG. 9 is a perspective view of a single piece created from the two smaller articles of FIG. 8 joined by two sheets of the thermoplastic polymer repair patch of FIG. 1A;

FIG. 10 is a perspective view of a section of a boat hull that has a damaged area;

FIG. 11 is a sectional view of the boat hull of FIG. 10 showing the fiberglass coating and damaged area;

FIG. 12 is a perspective view of a thermoplastic polymer repair patch with slightly angled sides;

FIG. 13 is a sectional view of the boat hull of FIG. 10 with the damaged area removed and a transition area from undamaged to damaged area created;

FIG. 14 is a sectional view of the boat hull of FIG. 14 and the soft thermoplastic polymer repair patch of FIG. 1A ready for molding into the damaged area;

FIG. 15 is a sectional view of the of the boat hull of FIG. 14 with the thermoplastic polymer repair patch of FIG. 1A molded into the damaged area;

FIG. 16 is a sectional view of the boat hull of FIG. 15 with the thermoplastic polymer repair patch machined and sanded such that the thermoplastic polymer repair patch and the boat hull are flush; and

FIG. 17 is a perspective view of the boat hull of FIG. 15 with the thermoplastic polymer repair patch of FIG. 1A molded into the damaged area.

### DETAILED DESCRIPTION OF THE INVENTION

Referring to the drawings in greater detail, this disclosure is directed to a thermoplastic polymer repair patch 6 comprising a thermoplastic polymer and a method of using the thermoplastic polymer repair patch 6.

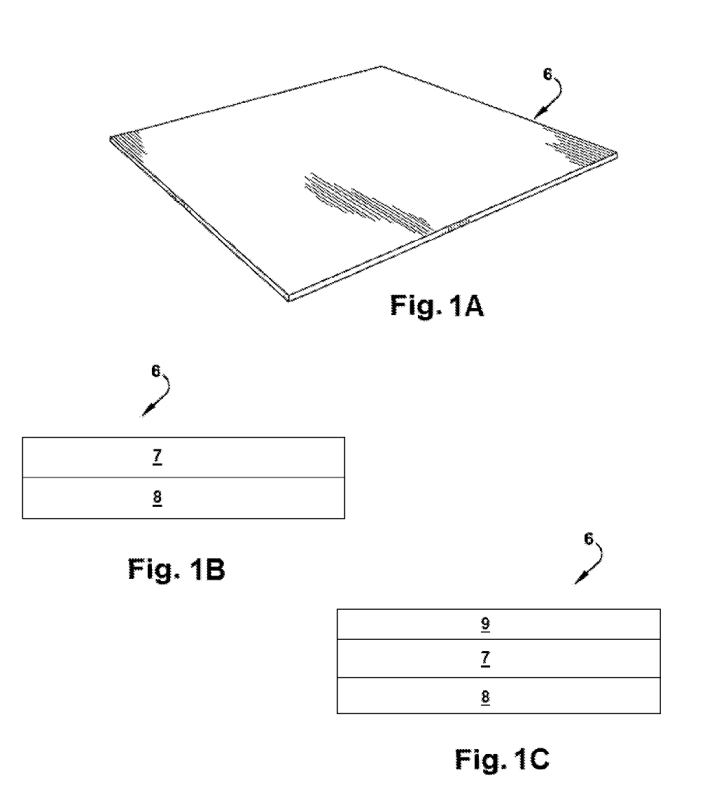

Referring initially to FIGS. 1A-1B, the thermoplastic polymer repair patch 6 for repairing manufactured parts having a damaged area is shown. In various embodiments the thermoplastic polymer repair patch 6 includes two layers, a first layer 8 comprising an adhesive and a second layer 7 comprising a thermoplastic polymer. The thermoplastic polymer repair patch 6 becomes soft upon heating and is capable of being deformed into a shape that is molded to the damaged area.

In various embodiments the thermoplastic polymer is specifically selected from the group consisting of acrylic-polyvinyl chloride, acrylonitrile-butadiene-styrene, polyethylene terephthalate glycol-modified (PETG), high impact polystyrene, polyvinyl chloride, and high density polyethylene. One having ordinary skill in the art would recognize that variations on the listed thermoplastic polymers are equally acceptable and appreciate that they may be substituted as an equivalent thereof. In selected embodiments the thermoplastic polymer is acrylic-polyvinyl chloride.

The thermoplastic polymer repair patch 6 may be in any desired preformed geometric shape. Specifically, in various embodiments the thermoplastic polymer repair patch is a flat square or rectangle. In further embodiments, embodiments the thermoplastic polymer repair patch is a flat oval or circle. Additional geometric shapes which are desirable for the thermoplastic polymer repair patch 6 would be known to one having skill in the art and may be determined based on the specific geometry of the manufactured parts requiring repair. For example, a preformed shape representing a 3-dimensional geometry is envisioned which allows the thermoplastic polymer repair patch 6 to substantially match the contours of a specific manufactured part with minimal additional shaping required at the time of placement.

In various embodiments of the thermoplastic polymer repair patch 6 comprises a pigment in the thermoplastic polymer. The pigment in the thermoplastic polymer provides for customizable coloration of the thermoplastic polymer repair patch 6 to be camouflaged or alternatively contrasting with the substrate. Non-limiting examples of pigments include Yellow HG, Red B, and Blue BG from Clariant; titanium oxide; and carbon black.

In order to mold the thermoplastic polymer repair patch 6 to the desired shape, the thermoplastic polymer repair patch 6 is heated, at which point the thermoplastic polymer and the entire thermoplastic polymer repair patch 6 become soft and can be mechanically deformed, typically by hand, to the desired shape. The steps of cooling the thermoplastic polymer repair patch 6 and bonding can be performed in the orders presented or reversed if it is desired to bond the patch in a hard state as opposed to a soft state. Additionally, in further embodiments, only a part of the patch may be heated in order to deform a portion of the patch, then cooling that portion of the patch and heating a second portion, iteratively, deforming the thermoplastic polymer repair patch 6 to the desired final shape. Once the thermoplastic polymer repair patch 6 has cooled, the thermoplastic polymer repair patch 6 will become rigid again and retain the new, deformed shape, and can be bonded to the damaged part with adhesives. The repair material of the thermoplastic polymer repair patch 6 conforms to the damaged area and retains the deformed shape without deactivation of the thermoplastic polymer. Thereafter, the deformed thermoplastic polymer repair patch 6 is bonded to the damaged area of the manufactured part.

Once formed, the thermoplastic polymer repair patch 6 can be deformed for easy storage, shipping, or immediate use by heating the thermoplastic polymer repair patch 6 until softened. If deformed for storage or shipping, simply reheating the thermoplastic polymer repair patch 6 will once again soften the thermoplastic polymer repair patch 6 and allow it to be subsequently deformed into the desired shape.

Referring to FIG. 1C, in further embodiments, the thermoplastic polymer repair patch 6 includes a third layer 9 which provides a customizable surface of the thermoplastic polymer repair patch 6. Non-limiting examples of the customizable surface include a colored surface distinct from the natural color of the thermoplastic polymer, a patterned surface, or a textured surface. A colored surface distinct from the natural color of the thermoplastic polymer, a patterned surface, or a textured surface allows the thermoplastic polymer repair patch 6 to be customized, for example, to have the same visual appearance as the manufactured parts and thus allows the thermoplastic polymer repair patch 6 to be camouflaged and less discrete. In various embodiments, the third layer 9 providing a customizable surface is printed onto the thermoplastic polymer of the second layer 8. In further embodiments, the third layer 9 providing a customizable surface is a distinct additional layer comprising a flexible material with a pattern embossed or similar therein, a pattern printed thereon, and/or comprising a desired color.

The thermoplastic polymer repair patch 6 having three distinct layers includes the thermoplastic polymer layer 7 sandwiched between the adhesive layer 8 and the customizable surface 9.

Because of the properties inherent in thermoplastic polymers, composite thermoplastic polymer repair patches 6 and non-composite thermoplastic polymer repair patches 6 can be temporarily softened, reshaped, and rapidly hardened in real-time to function in a variety of structural configurations.

Therefore, it can readily be seen that the present disclosure provides a quick and easy way to utilize a thermoplastic polymer repair patch 6 that has the flexibility of duct tape with the performance of composites and similar substances.

The non-thermoset nature of thermoplastic polymers allows the thermoplastic polymer repair patch 6 to be formed and processed via traditional thermoplastic processing techniques such as extrusion, vacuum forming, or injection molding.

It is therefore apparent that at least one exemplary embodiment provides a method for repairing manufactured parts of the type having a damaged area thereof. A thermoplastic polymer repair patch 6 comprising a repair material is preformed into a desired shape. The repair material comprises a thermoplastic polymer selected from the group consisting of acrylic-polyvinyl chloride, polyethylene terephthalate glycol-modified (PETG), high impact polystyrene, polyvinyl chloride, and high density polyethylene to create a thermoplastic polymer repair patch 6. The thermoplastic polymer is heated so that the preformed repair material becomes soft, and it is then deformed into a shape adapted for the repair function. Thereafter, the deformed thermoplastic polymer is bonded to the damaged area of the manufactured part.

A thermoplastic polymer provides advantages over a shape memory polymer as a thermoplastic polymer repair patch 6 is lower in cost and the materials have greater availability. The thermoplastic polymer repair patch 6 is deformable and conforms to a substrate when applied onto the substrate surface. The thermoplastic of the thermoplastic polymer repair patch 6 doesn't have a set memory, once the thermoplastic polymer repair patch 6 is deformed and as such it doesn't need to be restrained by force in order to stay in the deformed shape, as in a shape memory polymer patch. Thus, one step is eliminated in applying the thermoplastic polymer repair patch 6 in comparison to a shape memory polymer patch. This saves time in the repair process since the user does not need hold the thermoplastic polymer repair patch 6 in the desired shape and wait for completion of a deactivation step in order for the patch to stay in the desirable shape. Thus, the whole process is more efficient and less effort, which translate into lower repair cost in labor time.

In various embodiments the heating of said thermoplastic polymer is achieved by application of hot air, boiling water, use of an oven, a flame source, resistive heating, or an exothermic chemical reaction. In specific exemplary embodiments, the thermoplastic polymer is heated with a water-activated exothermic chemical heater such as is provided with a Meal, Ready to Eat. A Meal, Ready to Eat is a self-contained, individual field ration in lightweight packaging bought by, for example, a military for its service members for use in combat or other field conditions where organized food facilities are not available. A Meal, Ready to Eat is commonly known as an MRE.

The thermoplastic polymer repair patch 6 may include a thermal energy generation means embedded therein. Such thermal energy generation means may comprise, for example, thermally conductive fibers or electrical conductors. Additionally, when the thermoplastic polymer repair patch 6 comprises a thermal energy generation means embedded therein, it may be activated by applying electrical current to the thermal energy generation means.

The deformation step may be achieved via mechanical means such as hand pressing the patch against the surface of the contoured substrate, or by utilizing a roller to conform the thermoplastic polymer repair patch 6 with the substrate, by pressing in a press mold, by applying pressure on the back side of the patch by means of vacuum pressure, or by extruding the material through a rolling die mold.

In one exemplary embodiment, the thermoplastic polymer of the thermoplastic polymer repair patch 6 is returned to the rigid state by reducing the temperature thereof. In various embodiments the thermoplastic polymer is cooled to below 70° C. to harden the thermoplastic polymer and return the repair material to a rigid configuration. In further embodiments the thermoplastic polymer is cooled to below 50° C. to harden the thermoplastic polymer and return the repair material to a rigid configuration. In at least one embodiment, the reduction in temperature of the thermoplastic polymer can be accomplished while the thermoplastic polymer repair patch 6 is not actively maintained in the desired configuration by external forces. In at least one exemplary embodiment, the thermoplastic polymer patch is pressed by hand and/or a roller to a new configuration that conforms to the substrate surface to be repaired, the polymer patch is then set aside to cool unrestrained in the new configuration while the substrate or the polymer patch is being prepared for bonding to complete the intended repair operation. Another embodiment of such processes include profile extrusion through a profile extrusion die followed by air cooling to a configuration that is designed to match a specific product.

While a shape memory polymer experiences a phenomenon known as snap-back wherein the polymer must be forcibly retained in the deformed state until deactivation of the shape memory polymer, a thermoplastic polymer does not require active retention. Thus, the thermoplastic polymer repair patch 6 may be allowed to cool and regain a rigid configuration without requiring the active maintenance of the thermoplastic polymer repair patch 6 in the desired shape.

The manufactured part may comprise any solid material, such as metal, wood, plastic, ceramic, glass, or may be a composite part or similar material. The bonding step in accordance with this disclosure may be achieved via a host of conventional means such as via thermally cured adhesives or pressure sensitive adhesives.

The thermoplastic polymer repair patch 6 may comprise a composite material formed from fibrous or particulate material in combination with a thermoplastic polymer. In one form, the fibrous or particulate material may be embedded within the thermoplastic polymer or, in another form, the fibrous material can be impregnated with the thermoplastic polymer to form a layered composite.

The fibrous material may be chosen from carbon nanofibers, carbon fiber, spandex, chopped fiber, random fiber mat, fabric of any material, continuous fiber, fiberglass, or other types of textile fibers, yarns, and fabrics. For example, the fibrous material may be present in the form of a flat woven article, a two-dimensional weave, or a three-dimensional weave. Non-limiting examples of the particulate material include inorganic fillers such as carbon black, color pigments, silica, other inorganic oxides and ceramic particles.

Manufacture of the patch according to embodiments of this disclosure includes creating a thermoplastic polymer repair patch 6 comprising thermoplastic polymer. The thermoplastic polymer repair patch 6 may be of any required thickness in order to give the required structural strength in a particular circumstance. In specific embodiments the thickness of the thermoplastic polymer repair patch 6 is at least 0.010 inches. In further embodiments, the thickness of the thermoplastic polymer repair patch 6 is at least 0.020 inches. In still further embodiments, the thickness of the thermoplastic polymer repair patch 6 is at least 0.030 inches. Additionally, in specific embodiments the thickness of the thermoplastic polymer repair patch 6 is less than 0.250 inches. In further embodiments, the thickness of the thermoplastic polymer repair patch 6 is less than 0.120 inches. In still further embodiments, the thickness of the thermoplastic polymer repair patch 6 is less than 0.065 inches. The ranges generated from the upper and lower bounds in the various embodiments are also envisioned, such as 0.010 inches to 0.250 inches, 0.020 inches to 0.120 inches, and 0.020 inches to 0.065 inches. In selected specific embodiments the thermoplastic polymer repair patch 6 is approximately 0.020 inches thick, 0.028 inches thick, 0.030 inches thick, 0.04 inches thick 0.06 inches thick, or 0.12 inches thick.

The method of repairing all types of components and the thermoplastic polymer repair patch 6 all utilize the same common features. The following description therefore relates to all of these features.

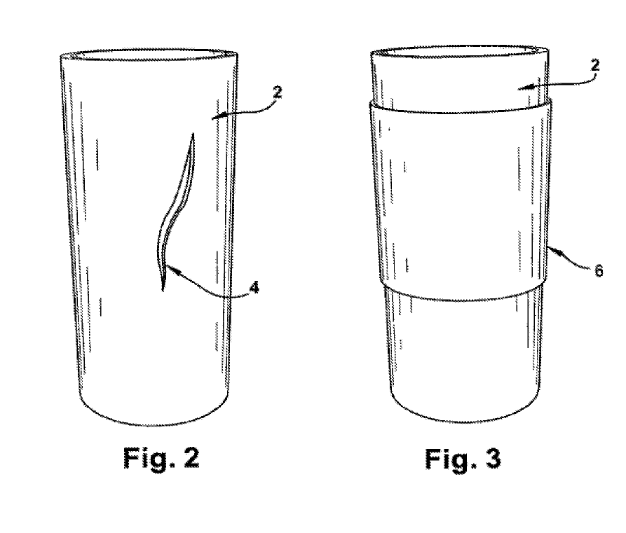

FIG. 2 shows a typical pipe 2 with a crack 4. FIGS. 1A-C shows a flat, essentially square piece of thermoplastic polymer repair patch 6. After heating, the thermoplastic polymer repair patch 6 will become soft and can be easily molded to a variety of shapes. In the present example, a technician, wearing gloves, can easily mechanically deform the thermoplastic polymer repair patch 6 to cover the crack 4 and follow the curvature of the pipe 2 as seen in FIG. 3 where the deformed thermoplastic polymer repair patch 6 covers the crack and essentially replicates the shape of the pipe. After bonding the thermoplastic polymer repair patch 6 to the pipe with an adhesive the pipe is repaired and can continue with normal operations.

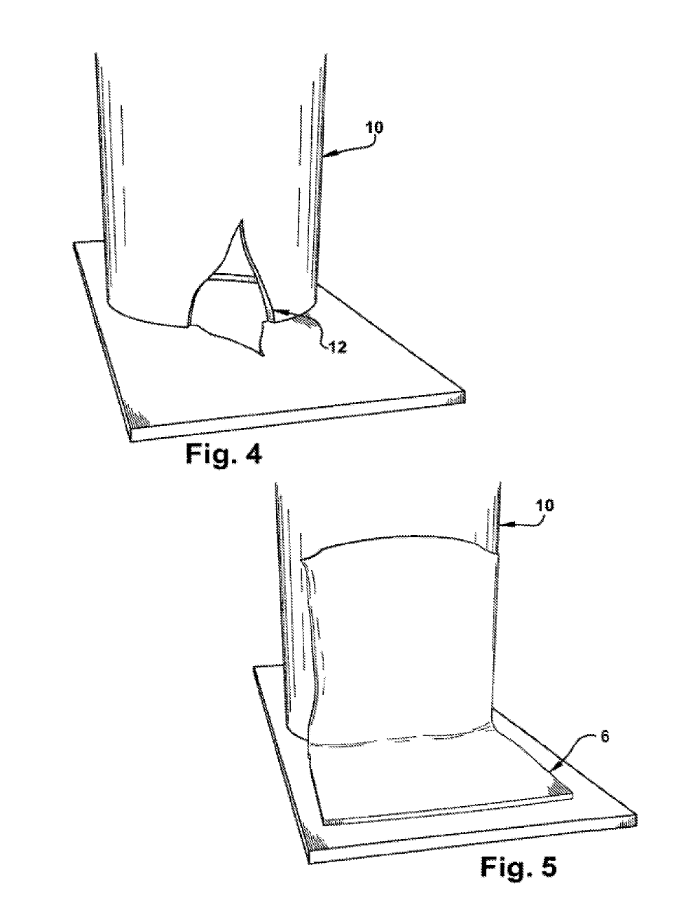

This process of patching various holes, cracks, leaks, breaks, and other damages is not limited to simple shapes. FIG. 4 shows a larger hole 12 at the joint between a pipe 10 and the ground, wall, or ceiling. Again, after heating, the thermoplastic polymer repair patch 6 will become soft and can be easily molded to cover the hole 12. In the present example, a technician, wearing gloves, can easily mechanically deform the thermoplastic polymer repair patch 6 to cover the hole 12 as seen in FIG. 5 where the deformed thermoplastic polymer repair patch 6 covers not only the hole 12 in pipe 10 but also ensures a good seal between the pipe 10 and the wall, ceiling, or floor. After bonding the patch to the pipe 10 and wall, ceiling, or floor with an adhesive, the pipe 10 is repaired and can continue with normal operations.

The mobile nature of the thermoplastic polymer repair patch 6 allows it to be molded on site by hand, iteratively or in one step, without the use of significant amounts of equipment or special orders to pre-mold the thermoplastic polymer repair patch 6 to match the specific damaged area. Another benefit is that by using thermoplastic polymer, the damaged part does not need to be removed from the larger component, for example removing the bumper from a vehicle, in order to mold the patch and repair the damage.

Additionally these repairs can be conducted not only by pure thermoplastic polymer repairs but also by composite thermoplastic polymers with a fibrous or particulate material in combination with the thermoplastic polymer which undergo the same heating, cooling, and bonding as seen in the above description.

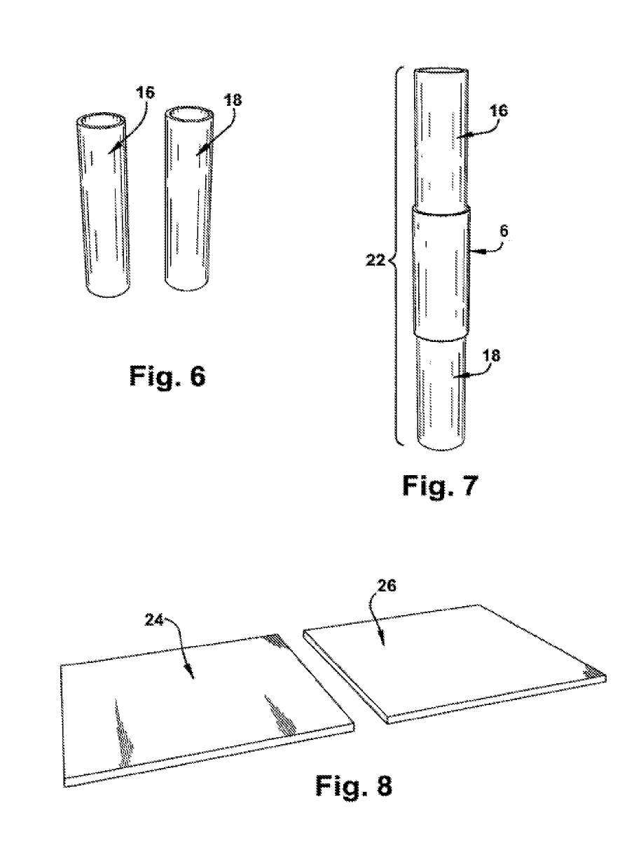

In accordance with another embodiment two or more parts are joined together in order to form larger parts. FIG. 6 shows two short pipes 16,18. If it is desired to create a larger pipe from these two it may be very difficult or time consuming to weld or otherwise join these short pipes 16,18. Using a thermoplastic polymer repair patch 6, a single new long pipe 22 can easily be made out of the two short pipes 16,18, as shown in FIG. 7. After placing the two short pipes 16,18 end to end in order to form a single new long pipe 22, the thermoplastic polymer repair patch 6 is heated and deformed around the junction of the short pipes 16,18 in order to effect a joining of the short pipes 16,18 with the deformed thermoplastic polymer repair patch 6. After bonding the patch to the short pipes 16,18 the new long pipe 22 is created. This entire process can be quick and reduces the emission and use of typically bonding or welding tools that create fire and chemical hazards upon use.

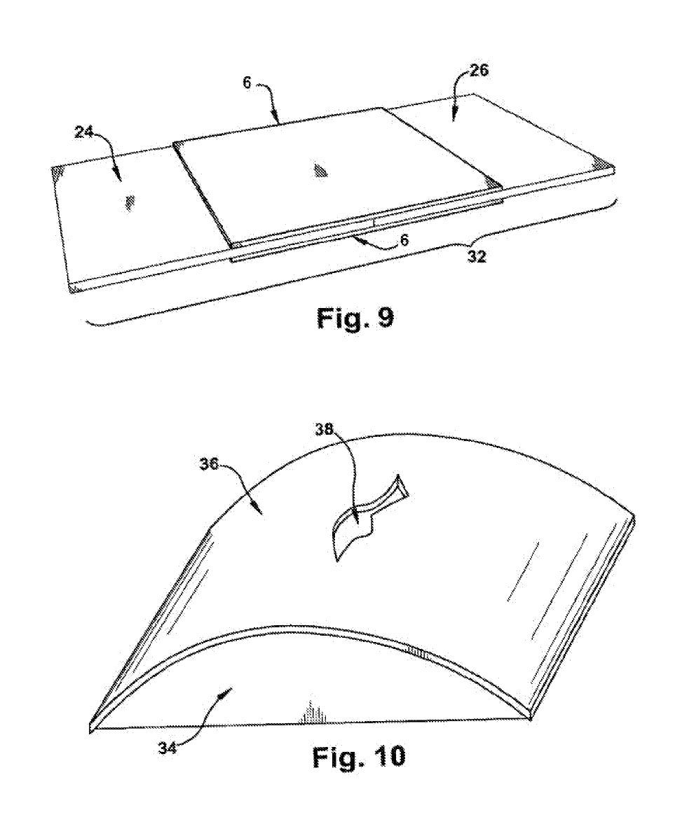

This embodiment is not limited to pipes and can be used to join other geometric shapes together. FIG. 8 shows flat panels 24,26 that may be joined. FIG. 9 shows that with the use of two thermoplastic polymer repair patches 6 the flat panels 24,26 can quickly be joined without deforming the thermoplastic polymer repair patches 6 or deforming the flat panels 24,26 so that the thermoplastic polymer repair patches 6 can match the minor changes in the shape of the boards. After bonding the thermoplastic polymer repair patches 6 to the flat panels 24,26, a new larger panel 32 is created.

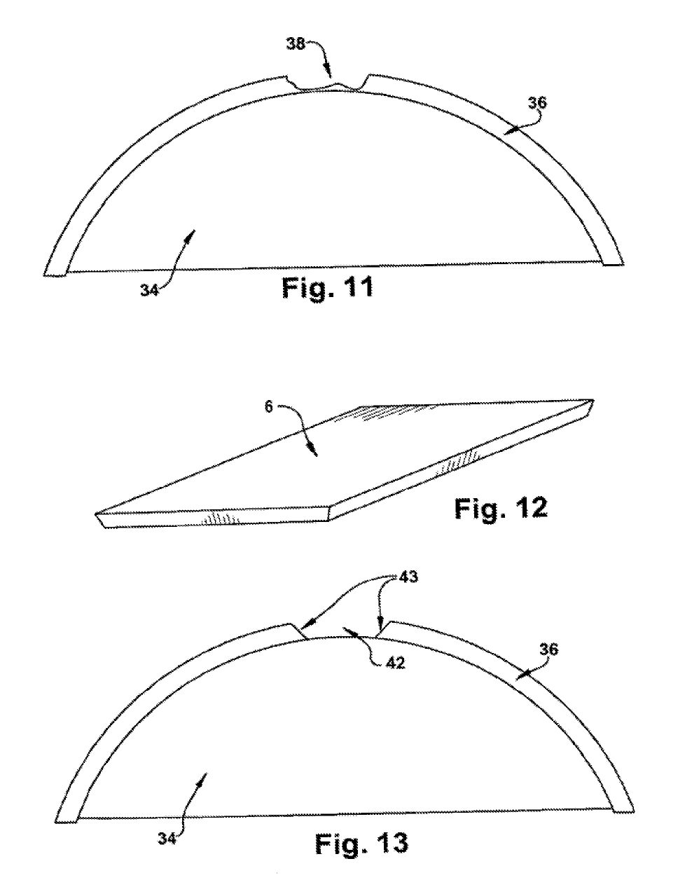

Another exemplary embodiment provides a means of permanent repair for manufactured parts that can significantly reduce the time required for repair. In FIG. 10 there is shown a section of a boat hull that has suffered damage 38. One having ordinary skill in the art would understand that the boat hull is a stand-in for any of a multitude of manufactured parts which may be in need of repair. The boat hull that has suffered damage 38 is made of a fiberglass outer layer 36 and a filler or foam inner layer 34. FIG. 11 shows a sectional view of the damaged hull 38 with the fiberglass outer layer 36 damaged from, for example, a piece of debris. While no damage is shown to the filler or foam inner layer 34 if such damage was present, this damage could be repaired with normal methods. FIG. 12 shows a thermoplastic polymer repair patch 6 comprising a composite patch material having a fiberglass portion in combination with the thermoplastic polymer. In order to repair the boat hull that has suffered damage 38, shown in FIGS. 10 and 11, the damaged area 42 must be removed as shown in FIG. 13, and a clean, smooth transition area 43 is created. As shown in FIG. 13 the boat hull has been prepared to create transition areas 43 on all sides of the damaged area 42 from undamaged fiberglass composite structure to the area to be repaired.

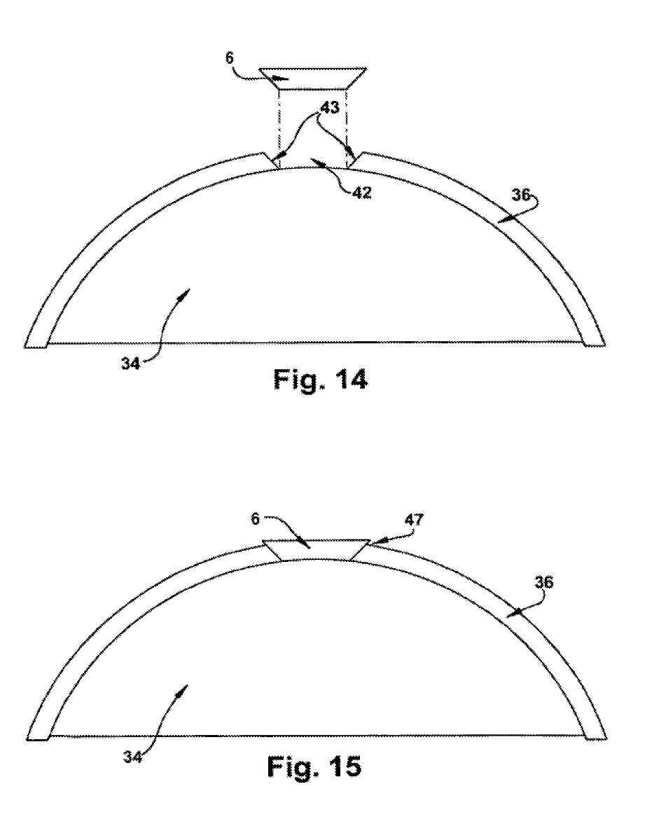

Once the surface has been prepared for repair using normal methods, the thermoplastic polymer repair patch 6 is heated to soften the thermoplastic polymer repair patch 6. As shown in FIG. 14 the thermoplastic polymer repair patch 6 is then initially deformed into a shape that will make it easier to mold into the damaged area 42 and the transition area 43. While the temperature of the thermoplastic polymer repair patch 6 is elevated such that thermoplastic polymer repair patch 6 is softened, the thermoplastic polymer repair patch 6 is formed and molded into the damaged area 42 and surrounded by the transition area 43 so that the entire damaged area 42 and transition area 43 are essentially covered by the thermoplastic polymer repair patch 6. As shown in FIG. 15 the now molded thermoplastic polymer repair patch 6 has been placed so as to essentially cover the entire damaged area 42. Additionally, the molded thermoplastic polymer repair patch 6, because of its soft and pliable state while heated, is able to fill in most gaps and crevices and completely replicate the entire damaged area 42 and machined transition area 43. As previously noted, this process requires no cure time as the thermoplastic polymer repair patch 6 is already in a cured state and must simply be cooled to regain rigidity. Once the thermoplastic polymer repair patch 6 has been molded to the desired area, simply allow the thermoplastic polymer repair patch 6 to cool to return the thermoplastic polymer repair patch 6 to a hard, rigid state. This process should only take a few minutes. Alternatively, the thermoplastic polymer repair patch 6 can be bonded to the damaged area 42.

In further embodiments, the thermoplastic polymer repair patch 6 can be used in combination with other repair process. The damaged area 38 in FIG. 10 can be first filled in with curable resin or glue. Once the resin or glue is set in place, the substrate can be sanded to provide a smooth surface. The thermoplastic polymer repair patch 6 is then heated to soften the patch for shaping into the right contour to fit the damaged substrate, and then applied onto the substrate with adhesive bonding to cover the repaired area. While the cured resin or glue by itself may not be strong enough to provide structural integrity to restore the original structural performance of the original substrate, the addition of the thermoplastic polymer repair patch 6 on top of the fill-in resin provides additional strength to the repair to attain the desired performance.

In yet further embodiments, the damaged area 38 can be first repaired by plastic welding and then the repair can be finished by application of the thermoplastic repair patch 6 to provide the desired additional strength to attain the desirable structural performance.

In multiple embodiment, the thermoplastic polymer repair patch 6 can be pre-formed for a specific contoured substrate, thereby reducing the time required to shape the thermoplastic polymer repair patch 6 during the repair operation.

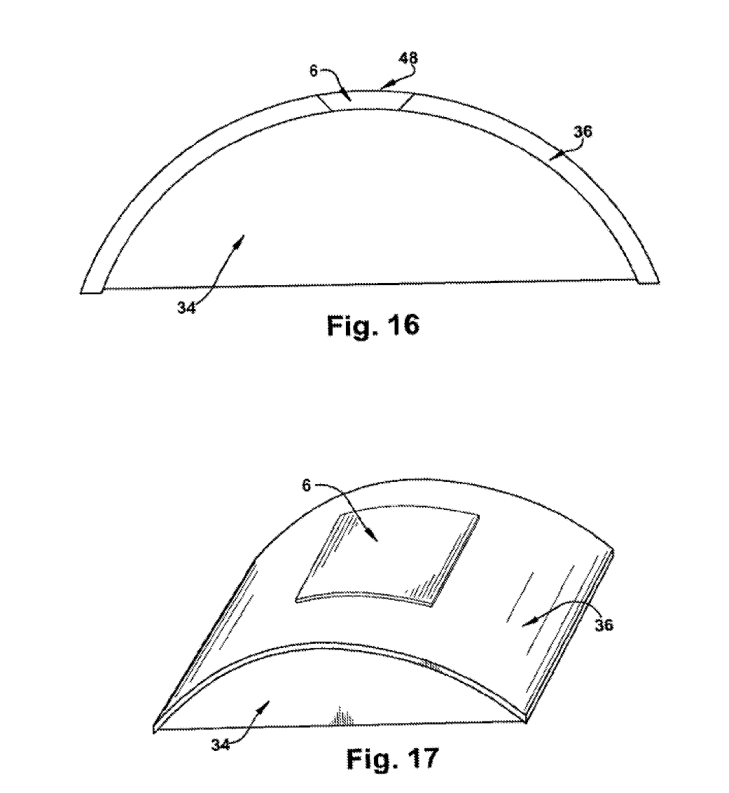

The thermoplastic polymer repair patch 6 can be bonded to the original part with a variety of systems discussed below. Once cooled and bonded to the original part it is possible that there will be some excess material that will rise above and/or not be flush with the original, undamaged surface 47, as shown in FIG. 15. This excess material can be removed through sanding or other machine processes as shown in FIG. 16 where the final surface 48 of the thermoplastic polymer repair patch 6 is now flush with the original part. FIG. 17 shows a final view of the thermoplastic polymer repair patch 6 used to fully repair the damaged hull 38 in FIG. 10. The thermoplastic polymer repair patch 6 is now flush with the surface and may be coated or painted as desired. It is also to be appreciated that this method of permanent repair can also be used for airplane parts, car parts, motorized vehicles, water craft, recreational vehicles, structural enclosures, mowers, hot tubs, car top carriers, and any other manufactured part that can be repaired using thermoplastic polymer material.

The method presented in this disclosure thus enables the use of the thermoplastic polymer repair patch 6 in a manner which avoids the use of a separate filler material which must be separately hardened and abraded flush with the surface to the repaired manufactured part prior to the application of the thermoplastic polymer repair patch 6 thereto with or without an additional separate adhesive. Additionally, the method of this disclosure enables use of a patch without any curing of the thermoplastic polymer repair patch 6, although a cured bonding agent can be used.

In order to bond the patch to a variety of systems, the adhesive must be chosen very carefully. There are a variety of commercially-available adhesive systems for use in bonding thermoplastic polymer repair patches 6 to different substrates. The wide range of adhesives will aid in developing different patch systems for different applications. Some adhesives are aerospace compatible, while others can only be used for ground applications or mass produced items. Cryogenic compatible adhesives are also available for use in repairing cryogenic pipes and tanks. These adhesives can be divided into two categories: thermally cured adhesives and pressure sensitive adhesives. The thermally cured adhesives chosen can be cured at or above the temperature at which the thermoplastic polymer repair patch 6 softens as pressure and heat are applied to cure the adhesive, and the patch is soft and easily formed around the area to be patched. The pressure sensitive adhesives are effective for quick repairs in fixing breaks, cracks or holes, and can be a permanent repair or a temporary repair. These adhesives allow for a quick “bandage-type” approach until a more permanent solution could be achieved. The following adhesives examples are for various applications, but is not intended to limit adhesives within the scope of the present disclosure to only those listed below:

### Thermally Cured Adhesives

3M Products Scotch-Weld AF 563K Film Adhesive

### Pressure Sensitive Adhesives

3M 9671LE

### Foam-Backed Adhesives

3M products 5925 VHB™ Tape

The thermally cured adhesives can be applied by: 1) forming the thermoplastic polymer patch around the area to be bonded (without adhesive); 2) applying adhesive to the patch; and then 3) bonding the preformed patch to the damaged area through thermal cure. This approach is the easiest and cleanest method for using paste-type adhesives. This method may be enhanced by using vacuum pressure during thermal cure and choosing an adhesive that has a cure temperature above the activation temperature of the thermoplastic polymer used for the patch. This would allow for a more intimate interface between the patch and the substrate during application. This helps promote distributed load transfer through the adhesive.

Pressure sensitive adhesives are applied to the thermoplastic polymer of the thermoplastic polymer repair patch 6 manually with the backing paper left intact in various embodiments. When repair is desired, 1) the patch/adhesive combination is heated above the softening temperature of the thermoplastic, 2) the backing paper is removed and 3) the patch is formed manually or with assistance and adhered simultaneously to the substrate. This method of adhesive application prior to use enables very fast repair scenarios. In further embodiments, the pressure sensitive adhesive can be applied to a pre-formed thermoplastic polymer repair patch 6 or to the substrate to be repaired before the repair operation. The pre-formed thermoplastic polymer repair patch 6 is then, with or without the pressure sensitive adhesive layer, heated above the softening temperature to allow for final fine adjustment of the shape to fit and to bond to the substrate.

In various embodiments, a thermally cured adhesive is applied to the repair material after it has been formed into the desired geometry and cooled. While a thermoplastic polymer does not exhibit snap-back like a shape memory polymer, choosing the correct thermoplastic polymer for use in combination with a thermally cured adhesive will prevent this curing from causing the thermoplastic polymer repair patch 6 to become soft again. It will be appreciated that adhesive cure temperatures could be as high as 180° C., but repairs in the field are likely to be more sound if a lower curing temperature adhesive is used to avoid the possibility of damage to the thermoplastic polymer repair patch 6 or further damage to the manufactured part being repaired. Where the adhesive is a curable resin the method may include the step of curing the adhesive for a period less than substantially one hour. Such a short curing time can dramatically shorten the overall repair time according to the method of this disclosure, especially when only the adhesive and not the thermoplastic polymer repair patch 6 require curing. Furthermore, some adhesives, such as pressure sensitive adhesives, require no curing, thus eliminating this concern.

It will be appreciated that when carrying out the repair method of this disclosure, all the normal preparatory work may be done to the damaged area in the usual way, for example thorough drying thereof, abrasion and cleaning of the surface to be repaired and debris and sharp edge removal. In various embodiments, best results for the repair are likely to be obtained when the liquid adhesive is painted onto all contact areas with a brush or the like to ensure good adhesion.

The following are examples of the process of bonding thermoplastic polymer patches to substrates according to aspects of this disclosure:

### Example 1

In order to bond a thermoplastic polymer repair patch 6 to a substrate the area around the damaged portion of the substrate or the area near the portions of the substrates to be joined to another is thoroughly cleaned. This may include scuff sanding and solvent wiping to ensure a clean, smooth bonding surface. Heat the thermoplastic polymer repair patch 6 in an oven or using another heat source until the thermoplastic polymer repair patch 6 reaches a temperature near or above 70° C., but below 132° C. More preferably, the thermoplastic polymer repair patch should be heat to a temperature range of 90° C. to 120° C. Remove the patch/adhesive from the oven, peel away the adhesive backing and form the thermoplastic polymer repair patch 6 to the substrate surface by applying pressure to shape and press the thermoplastic repair patch 6 into the contours of the substrate.

The bonding of the thermoplastic polymer repair patch 6 to various substrates such as fiberglass parts, metal builders, car fenders, and other composite parts, can be achieved using the method of Example 1 above. The method described above is useful and variations on the method may be chosen depending on the application. Thermally cured adhesives should generally be used for higher strength applications where time-to-repair is less critical such as airplane parts, load-bearing structural parts, and other parts with high strength or other mechanical properties. Conversely, pressure sensitive adhesives should generally be used for lower strength applications where time-to-repair is more critical or the cost or strength is not as important such as leaking pipes, a leaking boat, or other less demanding structural repairs. After bonding with the correct adhesive and thermoplastic polymer repair patch 6, the repaired part may be used normally.

Another aspect of the disclosure comprises joining a plurality of parts together via use of the thermoplastic polymer repair patch 6. Here, the parts are juxtaposed so that at least one joint or joinder area is formed. A preformed thermoplastic polymer repair patch 6 is provided and heated. The thermoplastic polymer repair patch 6 is then applied to the joint or joinder area and deformed into a desired shape. The thermoplastic polymer repair patch 6 is cooled to return the thermoplastic polymer repair patch 6 to a rigid state. In various embodiments, the thermoplastic polymer repair patch 6 is not held in place by any external force during the cooling of the thermoplastic polymer repair patch 6. The deformed shaped thermoplastic polymer repair patch 6 is then bonded to the joint area to effect joinder of the parts together.

Although this disclosure has been specifically directed to certain preferred embodiments, it will be appreciated that a wide variety of equivalents may be substituted for those specific elements shown and described herein, all without departing from the spirit and scope of the invention as defined in the appended claims.

What is claimed is:

1. A method for repairing manufactured parts having a damaged area comprising:
a. preforming a thermoplastic polymer repair patch comprising a repair material into a desired shape, said repair material comprising thermoplastic polymer selected from the group consisting of acrylic-polyvinyl chloride, polyethylene terephthalate glycol-modified (PETG), high impact polystyrene, polyvinyl chloride, high density polyethylene;
b. heating said thermoplastic polymer such that said preformed repair material becomes soft;
c. deforming said preformed repair material into a shape that is molded to the damaged area, wherein said deforming is achieved by external mechanical force; and
d. bonding said deformed repair material to said damaged area of said manufactured part, wherein one or more of steps b, c, and d can be iteratively repeated in any order to ensure that the repair material is molded to the damaged area.

2. The method of claim 1 wherein said heating of said thermoplastic polymer is achieved by application of hot air, boiling water, an oven, a flame source, resistive heating, or an exothermic chemical reaction.

3. The method of claim 1 wherein said heating of said thermoplastic polymer is achieved by application of a water-activated exothermic chemical heater.

4. The method of claim 1 wherein said thermoplastic polymer comprises acrylic-polyvinyl chloride.

5. The method of claim 1 wherein said external mechanical force is a roller.

6. The method of claim 1 wherein said external mechanical force is a hand.

7. The method of claim 1 further comprising allowing said deformed repair material to harden and retain its deformed shape without holding said deformed repair material in place by external force.

8. The method of claim 7 wherein said thermoplastic polymer is cooled to below 90° C., to harden said thermoplastic polymer.

9. The method of claim 7 wherein said thermoplastic polymer is cooled to below 70° C., to harden said thermoplastic polymer.

10. The method of claim 1 wherein said bonding is achieved by a pressure sensitive adhesive.

11. A method for repairing manufactured parts having a damaged area comprising:
a. preforming a thermoplastic polymer repair patch comprising a repair material into a desired shape, said repair material comprising a thermoplastic polymer;
b. heating said thermoplastic polymer such that said preformed repair material becomes soft;
c. deforming said preformed repair material into a shape that is conformed to the damaged area such that the repair material retains the shape that is conformed to the damaged area without deactivation of the thermoplastic polymer, wherein said deforming is achieved by external mechanical force; and
d. allowing said deformed repair material to harden and retains its deformed shape without holding said deformed repair material in place by external force; and
e. bonding said deformed repair material to said damaged area of said manufactured part, wherein one or more of steps b, c, d, and e can be iteratively repeated in any order to ensure that the repair material is molded to the damaged area.

12. The method of claim 11 wherein said thermoplastic polymer is selected from the group consisting of acrylic-polyvinyl chloride, acrylonitrile-butadiene-styrene (ABS), polyethylene terephthalate glycol-modified (PETG), high impact polystyrene, polyvinyl chloride, high density polyethylene.

13. The method of claim 11 wherein said thermoplastic polymer comprises acrylonitrile-butadiene-styrene.

14. The method of claim 11 wherein said thermoplastic polymer comprises acrylic-polyvinyl chloride

15. The method of claim 11 wherein said heating of said thermoplastic polymer is achieved by application of at least one of hot air, boiling water, an oven, a flame source, resistive heating, and an exothermic chemical reaction.

16. The method of claim 11 wherein said bonding is achieved by a pressure sensitive adhesive.

17. The method of claim 11 wherein said thermoplastic polymer is cooled to below 80° C., to harden said thermoplastic polymer.

18. A patch for repairing manufactured parts having a damaged area comprising
a first layer comprising an adhesive;
a second layer comprising a thermoplastic polymer selected from the group consisting of acrylic-polyvinyl chloride, polyethylene terephthalate glycol-modified (PETG), high impact polystyrene, polyvinyl chloride, high density polyethylene; and
wherein said thermoplastic polymer becomes soft upon heating and said patch is deformable into a shape that is molded to the damaged area.

19. The patch of claim 18 wherein said heating of said thermoplastic polymer is achieved by application of hot air, boiling water, an oven, a flame source, resistive heating, or chemical reaction.

20. The method of claim 18 wherein said heating of said thermoplastic polymer is achieved by application of a water-activated exothermic chemical heater.

21. The patch of claim 18 wherein said thermoplastic polymer comprises acrylic-polyvinyl chloride.

22. The patch of claim 18 wherein said adhesive is a pressure sensitive adhesive.

23. The patch of claim 18 wherein the thickness of the patch is between 0.020 inches and 0.120 inches.

24. The patch of claim 18 wherein the patch further comprises a third layer providing a customizable colored, patterned or textured surface.
